(19) United States
(12) Patent Application Publication
(10) Pub. No.: US 2024/0194215 A1
(43) Pub. Date: Jun. 13, 2024

(54) EQUALIZING AND TRACKING SPEAKER VOICES IN SPATIAL CONFERENCING

(71) Applicant: Intel Corporation, Santa Clara, CA (US)

(72) Inventors: Sumod CHERUKKATE, Bangalore (IN); Willem BELTMAN, West Linn, OR (US); Mallari HANCHATE, Bangalore (IN); Srikanth POTLURI, Folsom, CA (US); Sangeeta MANEPALLI, Chandler, AZ (US); Abhishek SRIVASTAV, Bangalore (IN)

(21) Appl. No.: 18/078,051

(22) Filed: Dec. 8, 2022

(51) Int. Cl. G10L 21/0364; G06F 3/01; G06T 7/50; G06V 40/16; H04R 1/32

(52) U.S. Cl. CPC G10L 21/0364; G06F 3/013; G06T 7/50; G06V 40/172; H04R 1/326

(57) ABSTRACT

This disclosure describes systems, methods, and devices related to user tracking. A device may identify metadata comprising depth sensing information and camera information received from an in-room device located at a first location having a first camera. The device may perform face recognition on one or more in-room users. The device may calculate a distance of a first in-room user based on the metadata and a first number of pixels across the face of the first in-room user. The device may calculate a distance between the first in-room user and a second in-room user based on the metadata and the first number of pixels across the face of the first in-room user and a number of pixels across the face of the second in-room user.

### TECHNICAL FIELD

This disclosure generally relates to systems and methods for spatial conferencing and, more particularly, to equalizing and tracking speaker voices in spatial conferencing.

### BACKGROUND

Video coding can be a lossy process that sometimes results in reduced quality when compared to the original source video. Video coding standards are being developed to improve video quality.

### BRIEF DESCRIPTION OF THE DRAWINGS

FIG. 1 depicts an example system illustrating components of encoding and decoding devices, in accordance with one or more example embodiments of the present disclosure.

FIG. 2 depicts an illustrative schematic diagram for tracking, in accordance with one or more example embodiments of the present disclosure.

FIGS. 3 and 4 depict illustrative schematic diagrams for spatial conference implementation block diagrams.

FIGS. 5 and 6 depict illustrative schematic diagrams for tracking, in accordance with one or more example embodiments of the present disclosure.

FIG. 7 depicts an illustrative schematic diagram for tracking, in accordance with one or more example embodiments of the present disclosure.

FIG. 8 depicts an illustrative schematic diagram for tracking, in accordance with one or more example embodiments of the present disclosure.

FIGS. 9 and 10 depict illustrative schematic diagrams for tracking, in accordance with one or more example embodiments of the present disclosure.

FIG. 11 depicts an illustrative schematic diagram for tracking, in accordance with one or more example embodiments of the present disclosure.

FIG. 12 depicts an illustrative schematic diagram for tracking, in accordance with one or more example embodiments of the present disclosure.

FIG. 13 depicts an illustrative schematic diagram for tracking, in accordance with one or more example embodiments of the present disclosure.

FIG. 14 illustrates a flow diagram of a process for an illustrative tracking system, in accordance with one or more example embodiments of the present disclosure.

FIG. 15 is a block diagram illustrating an example of a computing device or computing system upon which any of one or more techniques (e.g., methods) may be performed, in accordance with one or more example embodiments of the present disclosure.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers in the figures. refer to like elements throughout. Hence, if a feature is used across several drawings, the number used to identify the feature in the drawing where the feature first appeared will be used in later drawings.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

When multiple people in a room (henceforth referred to as “in-room users” in this disclosure) use a single device (e.g., a laptop, computer, or another device) for video conferencing with others, the far-end user(s) expects the incoming voice of each actively participating in-room user to be loud and clear. Current noise reduction techniques do not cater to this expectation and are designed for a single user using the device. Also, the sensitivity of the voices detected by the microphone array will be different based on the in-room user's physical location with respect to the device. This results in the voices of different in-room users being detected at different levels. Also, far-end users do not have the flexibility to focus only on a single in-room user's voice in case other users participate less or become noisy in the meeting.

Current solutions do not address the above problems. For example, fixed beamforming techniques and fixed microphone gain settings are designed with the assumption that a user is seated at a specific distance in front of a laptop. Fixed beamforming techniques and fixed microphone gain settings assume there is only one user. Adaptive beamforming techniques are dynamically directed at the user who is speaking. Adaptive beamforming techniques detect the loudest sound in the voice band even if it is noise. Automatic Gain Control (AGC) is based on the voice level, which can introduce artifacts. For example, the algorithm cannot distinguish a proper low voice versus a low voice because the user is far away. Also, commercial conferencing room solutions have a different scope. They have complex hardware (HW)/software (SW) on the in-room side and provide a good mono experience on the far end. They too employ adaptive beamforming techniques but, only in a noise-controlled environment.

Example embodiments of the present disclosure relate to systems, methods, and devices for equalizing and tracking speaker voices in spatial conferencing.

In one or more embodiments, a tracking system may combine spatial conferencing and in-room users' physical locations to appropriately tune the conferencing on the far end side (downstream or playback side). Spatial conferencing involves spatializing in-room users' voice to respective directions (based on their physical locations) on the far end device.

In one or more embodiments, a tracking system may add the capability to increase, decrease, or mute voice levels specific to each direction. For equalization, the tracking system will suitably increase or decrease voice levels based on in-room users' depth information. For tracking a specific in-room user's voice, the tracking system may not change the voice level coming from the direction of the specific user but will mute the voice levels coming from other directions.

In one or more embodiments, a tracking system may derive in-room users' physical locations through metadata periodically updated from an in-room device (e.g., a PC) or through face IDs in the video stream, or a combination of both.

In one or more embodiments, a tracking system may automatically or manually focus on a single user's voice (audio smart framing) among multiple users in the background during video conferencing.

In one or more embodiments, a tracking system may automatically equalize all the user's voices even if they are seated at different distances from the in-room device.

In one or more embodiments, a tracking system may run on a far end device where user experience is enhanced. The tracking system may run on downstream (e.g., speaker playback) as part of post processing.

In one or more embodiments, a tracking system may not require any additional hardware. The tracking system can be part of audio post processing. The tracking system can work on current stereo conferencing applications.

The above descriptions are for purposes of illustration and are not meant to be limiting. Numerous other examples, configurations, processes, algorithms, etc., may exist, some of which are described in greater detail below. Example embodiments will now be described with reference to the accompanying Figures.

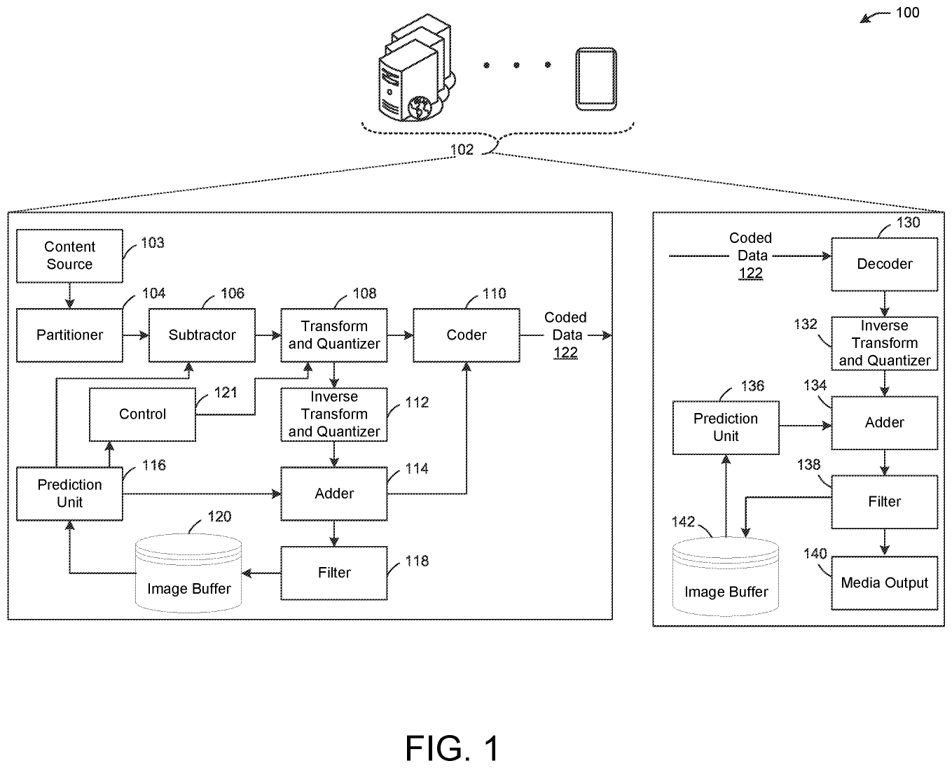

FIG. 1 depicts an example system 100 illustrating components of encoding and decoding devices, according to some example embodiments of the present disclosure.

Referring to FIG. 1, the system 100 may include devices 102 having encoder and/or decoder components. As shown, the devices 102 may include a content source 103 that provides video and/or audio content (e.g., a camera or other image capture device, stored images/video, etc.). The content source 103 may provide media (e.g., video and/or audio) to a partitioner 104, which may prepare frames of the content for encoding. A subtractor 106 may generate a residual as explained further herein. A transform and quantizer 108 may generate and quantize transform units to facilitate encoding by a coder 110 (e.g., entropy coder). Transform and quantized data may be inversely transformed and inversely quantized by an inverse transform and quantizer 112. An adder 114 may compare the inversely transformed and inversely quantized data to a prediction block generated by a prediction unit 116, resulting in reconstructed frames. A filter 118 (e.g., in-loop filter for resizing/cropping, color conversion, de-interlacing, composition/blending, etc.) may revise the reconstructed frames from the adder 114, and may store the reconstructed frames in an image buffer 120 for use by the prediction unit 116. A control 121 may manage many encoding aspects (e.g., parameters) including at least the setting of a quantization parameter (QP) but could also include setting bitrate, rate distortion or scene characteristics, prediction and/or transform partition or block sizes, available prediction mode types, and best mode selection parameters, for example, based at least partly on data from the prediction unit 116. Using the encoding aspects, the transform and quantizer 108 may generate and quantize transform units to facilitate encoding by the coder 110, which may generate coded data 122 that may be transmitted (e.g., an encoded bitstream).

Still referring to FIG. 1, the devices 102 may receive coded data (e.g., the coded data 122) in a bitstream, and a decoder 130 may decode the coded data, extracting quantized residual coefficients and context data. An inverse transform and quantizer 132 may reconstruct pixel data based on the quantized residual coefficients and context data. An adder 134 may add the residual pixel data to a predicted block generated by a prediction unit 136. A filter 138 may filter the resulting data from the adder 134. The filtered data may be output by a media output 140, and also may be stored as reconstructed frames in an image buffer 142 for use by the prediction unit 136.

Referring to FIG. 1, the system 100 performs the methods of intra prediction disclosed herein, and is arranged to perform at least one or more of the implementations described herein including intra block copying. In various implementations, the system 100 may be configured to undertake video coding and/or implement video codecs according to one or more standards. Further, in various forms, video coding system 100 may be implemented as part of an image processor, video processor, and/or media processor and undertakes inter-prediction, intra-prediction, predictive coding, and residual prediction. In various implementations, system 500 may undertake video compression and decompression and/or implement video codecs according to one or more standards or specifications, such as, for example, H.264 (Advanced Video Coding, or AVC), VP8, H.265 (High Efficiency Video Coding or HEVC) and SCC extensions thereof, VP9, Alliance Open Media Version 1 (AV1), H.266 (Versatile Video Coding, or VVC), DASH (Dynamic Adaptive Streaming over HTTP), and others. Although system 100 and/or other systems, schemes or processes may be described herein, the present disclosure is not necessarily always limited to any particular video coding standard or specification or extensions thereof.

As used herein, the term “coder” may refer to an encoder and/or a decoder. Similarly, as used herein, the term “coding” may refer to encoding via an encoder and/or decoding via a decoder. A coder, encoder, or decoder may have components of both an encoder and decoder. An encoder may have a decoder loop as described below.

For example, the system 100 may be an encoder where current video information in the form of data related to a sequence of video frames may be received to be compressed. By one form, a video sequence (e.g., from the content source 103) is formed of input frames of synthetic screen content such as from, or for, business applications such as word processors, power points, or spread sheets, computers, video games, virtual reality images, and so forth. By other forms, the images may be formed of a combination of synthetic screen content and natural camera captured images. By yet another form, the video sequence only may be natural camera captured video. The partitioner 104 may partition each frame into smaller more manageable units, and then compare the frames to compute a prediction. If a difference or residual is determined between an original block and prediction, that resulting residual is transformed and quantized, and then entropy encoded and transmitted in a bitstream, along with reconstructed frames, out to decoders or storage. To perform these operations, the system 100 may receive an input frame from the content source 103. The input frames may be frames sufficiently pre-processed for encoding.

The system 100 also may manage many encoding aspects including at least the setting of a quantization parameter (QP) but could also include setting bitrate, rate distortion or scene characteristics, prediction and/or transform partition or block sizes, available prediction mode types, and best mode selection parameters to name a few examples.

The output of the transform and quantizer 308 may be provided to the inverse transform and quantizer 112 to generate the same reference or reconstructed blocks, frames, or other units as would be generated at a decoder such as decoder 130. Thus, the prediction unit 116 may use the inverse transform and quantizer 112, adder 114, and filter 118 to reconstruct the frames.

The prediction unit 116 may perform inter-prediction including motion estimation and motion compensation, intra-prediction according to the description herein, and/or a combined inter-intra prediction. The prediction unit 116 may select the best prediction mode (including intra-modes) for a particular block, typically based on bit-cost and other factors. The prediction unit 116 may select an intra-prediction and/or inter-prediction mode when multiple such modes of each may be available. The prediction output of the prediction unit 116 in the form of a prediction block may be provided both to the subtractor 106 to generate a residual, and in the decoding loop to the adder 114 to add the prediction to the reconstructed residual from the inverse transform to reconstruct a frame.

The partitioner 104 or other initial units not shown may place frames in order for encoding and assign classifications to the frames, such as I-frame, B-frame, P-frame and so forth, where I-frames are intra-predicted. Otherwise, frames may be divided into slices (such as an I-slice) where each slice may be predicted differently. Thus, for HEVC or AV1 coding of an entire I-frame or I-slice, spatial or intra-prediction is used, and in one form, only from data in the frame itself.

In various implementations, the prediction unit 116 may perform an intra block copy (IBC) prediction mode and a non-IBC mode operates any other available intra-prediction mode such as neighbor horizontal, diagonal, or direct coding (DC) prediction mode, palette mode, directional or angle modes, and any other available intra-prediction mode. Other video coding standards, such as HEVC or VP9 may have different sub-block dimensions but still may use the IBC search disclosed herein. It should be noted, however, that the foregoing are only example partition sizes and shapes, the present disclosure not being limited to any particular partition and partition shapes and/or sizes unless such a limit is mentioned or the context suggests such a limit, such as with the optional maximum efficiency size as mentioned. It should be noted that multiple alternative partitions may be provided as prediction candidates for the same image area as described below.

The prediction unit 116 may select previously decoded reference blocks. Then comparisons may be performed to determine if any of the reference blocks match a current block being reconstructed. This may involve hash matching, SAD search, or other comparison of image data, and so forth. Once a match is found with a reference block, the prediction unit 116 may use the image data of the one or more matching reference blocks to select a prediction mode. By one form, previously reconstructed image data of the reference block is provided as the prediction, but alternatively, the original pixel image data of the reference block could be provided as the prediction instead. Either choice may be used regardless of the type of image data that was used to match the blocks.

The predicted block then may be subtracted at subtractor 106 from the current block of original image data, and the resulting residual may be partitioned into one or more transform blocks (TUs) so that the transform and quantizer 108 can transform the divided residual data into transform coefficients using discrete cosine transform (DCT) for example. Using the quantization parameter (QP) set by the system 100, the transform and quantizer 108 then uses lossy resampling or quantization on the coefficients. The frames and residuals along with supporting or context data block size and intra displacement vectors and so forth may be entropy encoded by the coder 110 and transmitted to decoders.

In one or more embodiments, a system 100 may have, or may be, a decoder, and may receive coded video data in the form of a bitstream and that has the image data (chroma and luma pixel values) and as well as context data including residuals in the form of quantized transform coefficients and the identity of reference blocks including at least the size of the reference blocks, for example. The context also may include prediction modes for individual blocks, other partitions such as slices, inter-prediction motion vectors, partitions, quantization parameters, filter information, and so forth. The system 100 may process the bitstream with an entropy decoder 130 to extract the quantized residual coefficients as well as the context data. The system 100 then may use the inverse transform and quantizer 132 to reconstruct the residual pixel data.

The system 100 then may use an adder 134 (along with assemblers not shown) to add the residual to a predicted block. The system 100 also may decode the resulting data using a decoding technique employed depending on the coding mode indicated in syntax of the bitstream, and either a first path including a prediction unit 136 or a second path that includes a filter 138. The prediction unit 136 performs intra-prediction by using reference block sizes and the intra displacement or motion vectors extracted from the bitstream, and previously established at the encoder. The prediction unit 136 may utilize reconstructed frames as well as inter-prediction motion vectors from the bitstream to reconstruct a predicted block. The prediction unit 136 may set the correct prediction mode for each block, where the prediction mode may be extracted and decompressed from the compressed bitstream.

In one or more embodiments, the coded data 122 may include both video and audio data. In this manner, the system 100 may encode and decode both audio and video.

It is understood that the above descriptions are for purposes of illustration and are not meant to be limiting.

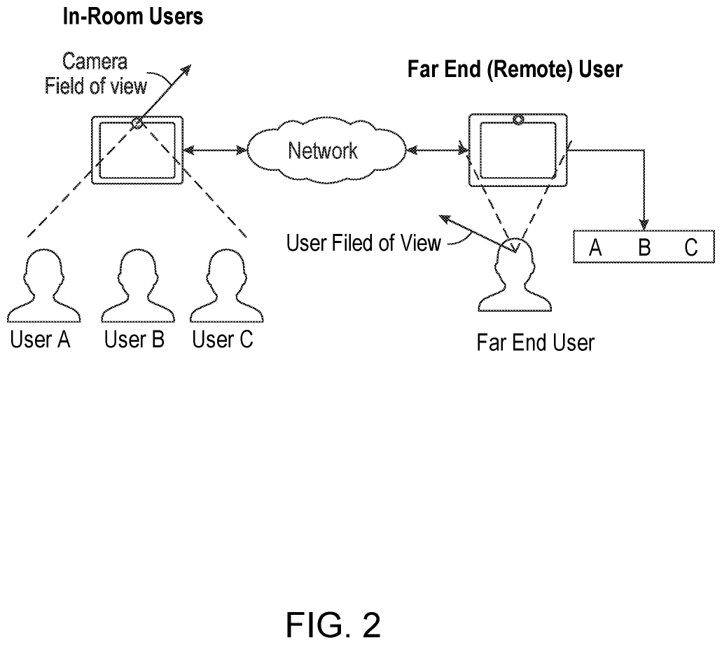

FIG. 2 depicts an illustrative schematic diagram for tracking, in accordance with one or more example embodiments of the present disclosure.

Referring to FIG. 2, there is shown a block diagram of spatial conferencing.

The feature enables the far end user in FIG. 2 to hear in-room users' voices in different directions based on their physical locations. The far end user will hear User A's voice on the left, User B's voice in the middle, and User C's voice on the right.

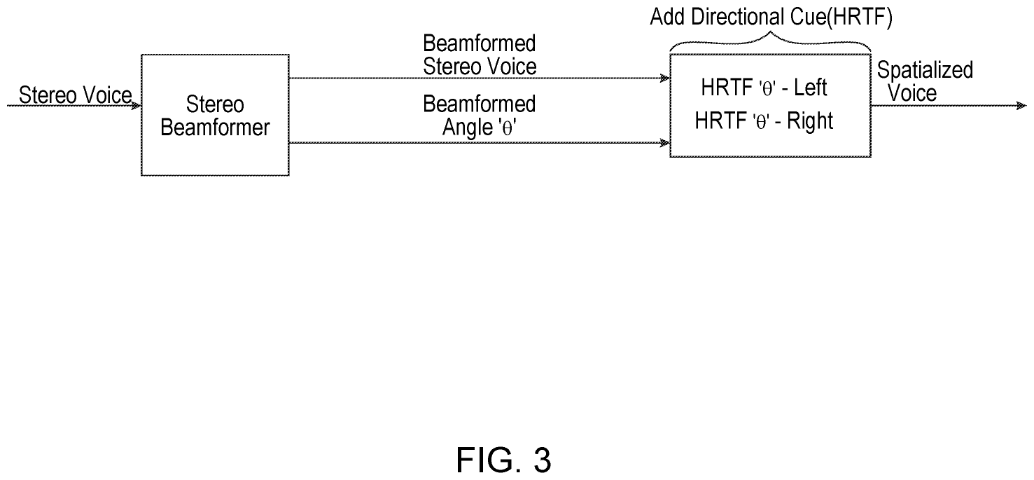

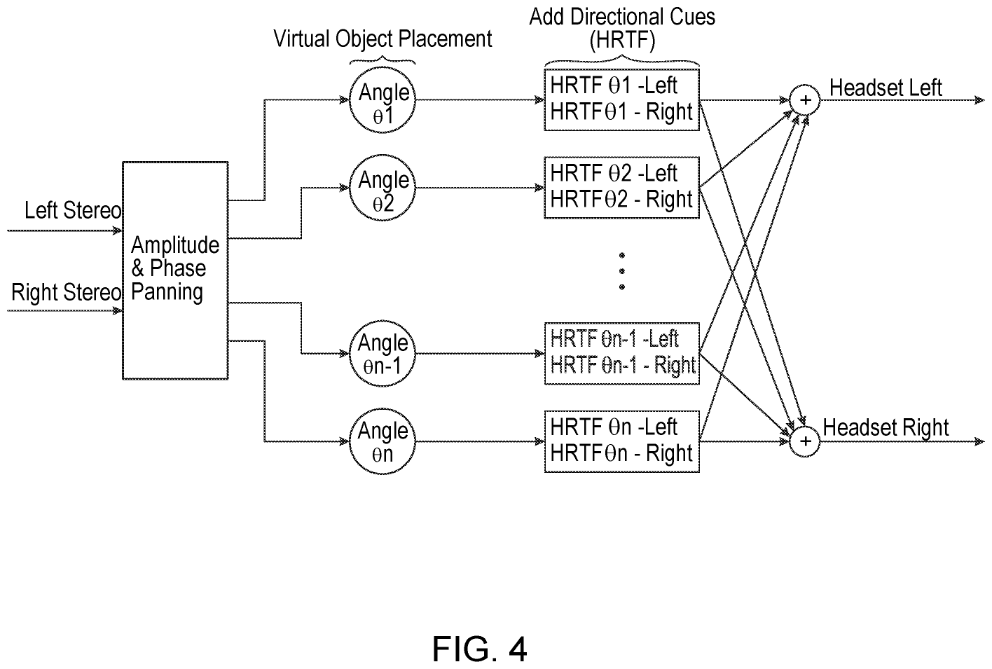

FIGS. 3 and 4 depict illustrative schematic diagrams for spatial conference implementation block diagrams.

Referring to FIG. 3, there is shown a spatial conference implementation block diagram. The stereo beamformer will steer to the voice that is loudest and pass the beamformed voice and angle to head related transfer functions (HRTF) filters to rotate the sound stage. On the remote side, there is stereo beamforming that can capture sound coming in a particular direction. In addition, a spatialization block receives the angle and the beamformed stereo voice. The spatialization block adds a directional cue to generate spatialized voice.

Referring to FIG. 4, there is shown a spatial conference implementation block diagram based on virtual objects that could bring in a more immersive conference experience.

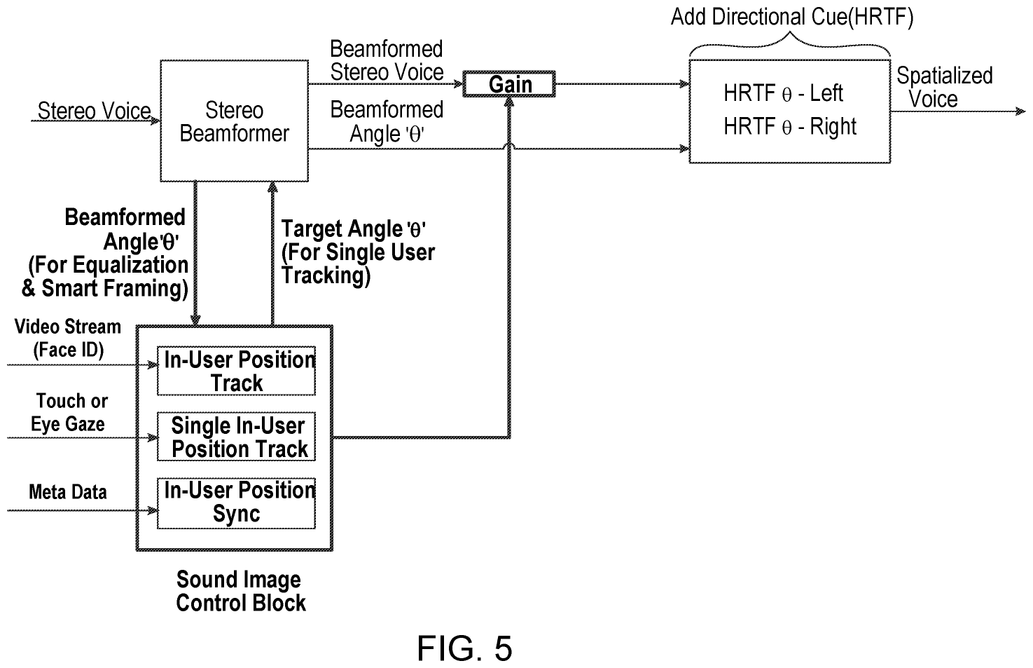

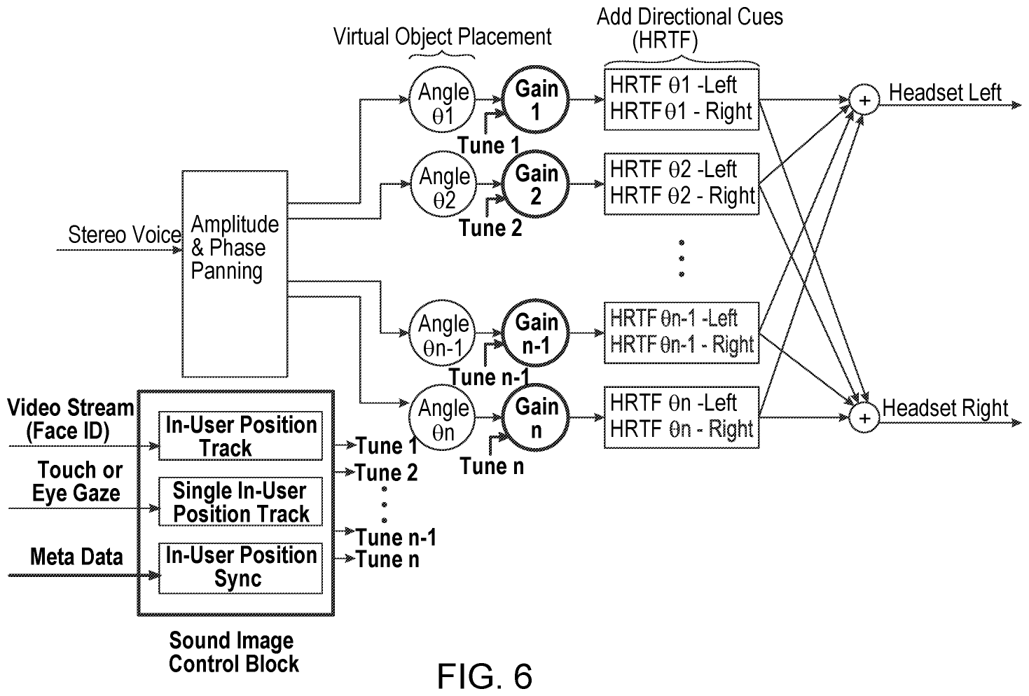

FIGS. 5 and 6 depict illustrative schematic diagrams for tracking, in accordance with one or more example embodiments of the present disclosure.

Referring to FIG. 5, there is shown the use of a sound image control block that takes inputs from a video streaming data through face IDs, user display touch data, and metadata from an in-room device and in turn alters (e.g., gain) the voice levels streamed in different directions. The alteration could either be to equalize the voices or enhance a particular voice.

In one or more embodiments, the input data may comprise:

1) Metadata from the in-room device will be used for synchronizing the in-room users' physical locations that are locally created on the far end side. Metadata consists of Face IDs of the in-room users tagged with their locations. Each metadata will be time-stamped or tagged with the corresponding screen image. This data is sent at the start of conferencing to far end devices so that each of them can build a local reference plane for calculating in-room user physical locations. The data will be sent again when a new in-room user joins or leaves. The data will be sent on a periodic basis if necessary for synchronizing location info.

2) Video stream data, through face ID (with pixel count across the face) should provide dynamic relative in-room user physical locations. This data is combined with metadata to create dynamic in-room users' actual physical locations on the far end side.

3) Touch data is for the far end user to manually select an in-room user through touch on the display screen to track his or her voice.

4) Eye gaze is for the far end user to get an enhanced voice level of the in-room user he/she is looking at on the screen. Eye gaze is captured on the far-end side camera to focus on a particular in-room user's voice (among multiple in-room users). Because stereo beamforming is at the far end, linking eye-gaze with far-end stereo beamforming is much simpler and devoid of latency issues.

An example implementation of a sound image control on object based spatial conferencing is shown in FIG. 6.

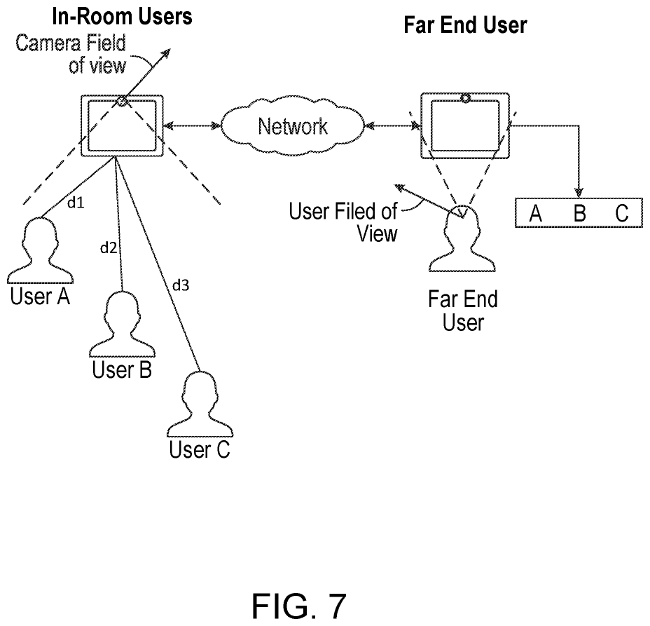

FIG. 7 depicts an illustrative schematic diagram for tracking, in accordance with one or more example embodiments of the present disclosure.

Referring to FIG. 7, there are shown three in-room users (A, B, and C). These in-room users may be located at different depths/distances (e.g., d1, d2, and d3) from their devices. Their respective voices will be captured at different sensitivities.

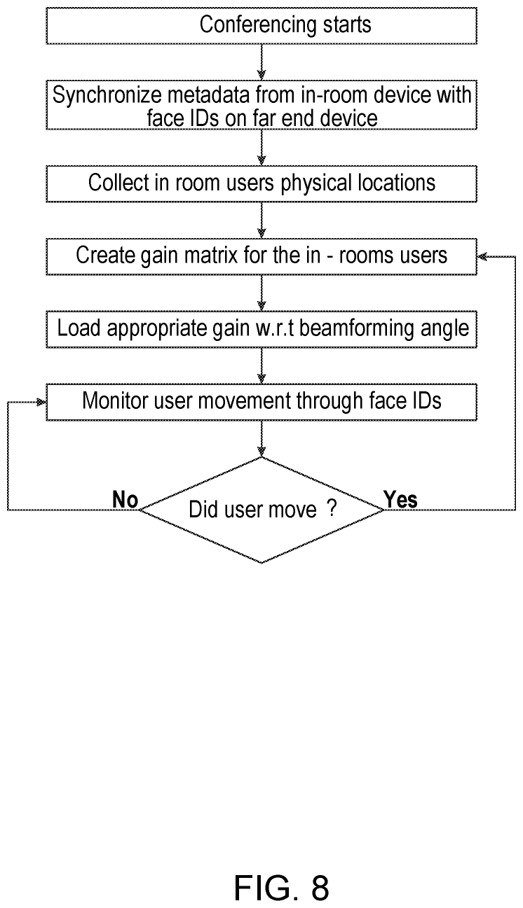

FIG. 8 depicts an illustrative schematic diagram for tracking, in accordance with one or more example embodiments of the present disclosure.

Referring to FIG. 8, there is shown a tracking process running on the far end device for equalizing multiple in-room users.

In this flow diagram, a remote device on the remote side, after the conferencing starts, may synchronize metadata from the in-room device with face IDs. The remote device may then collect in-room users' physical locations and create a gain matrix for the in-room users. The remote device may load appropriate gain with respect to beamforming angles associated with the in-room users. The remote device may monitor user movements through face IDs and track the user based on that.

For example, in FIG. 7, if User B is at the mean position, User A closer to the device at half the mean distance and User C is twice the mean distance, then gain settings will be −6 dB for User A, 0 dB for User B and +6 dB for User C.

In one or more embodiments, a tracking system may facilitate tracking and auto-framing single in-room user voice.

In scenarios where few in-room users in the midway of the meeting may no longer be active participants, for example, say Users B and C in FIG. 2, then far end user would prefer to enhance User A's voice over B and C. In such a scenario, a tracking system may enable far end users to manually select User A through display touch and track his/her voice. The same could be tied with far end users' eye gaze but instead could be used for voice enhancement. It is understood that the above descriptions are for purposes of illustration and are not meant to be limiting.

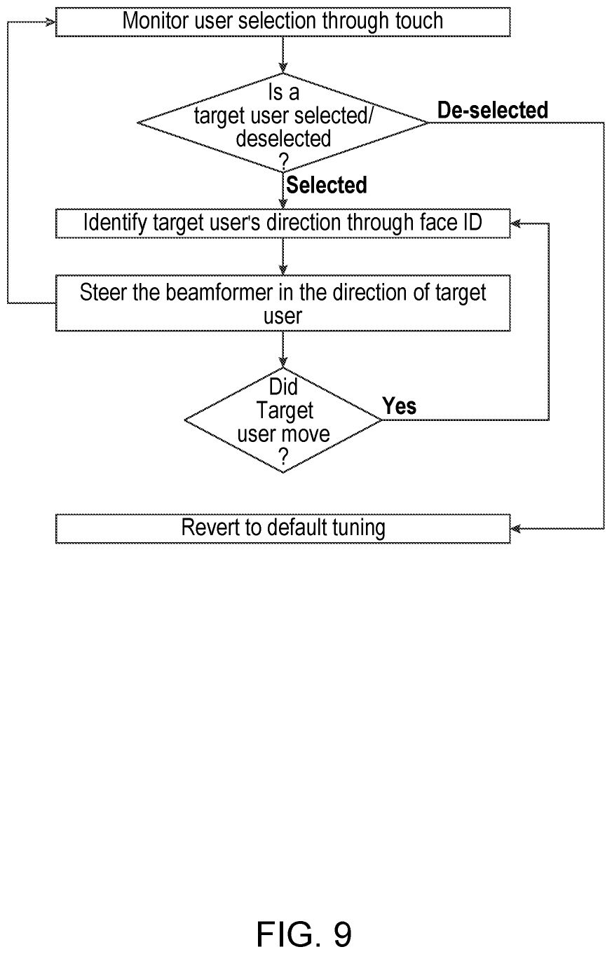

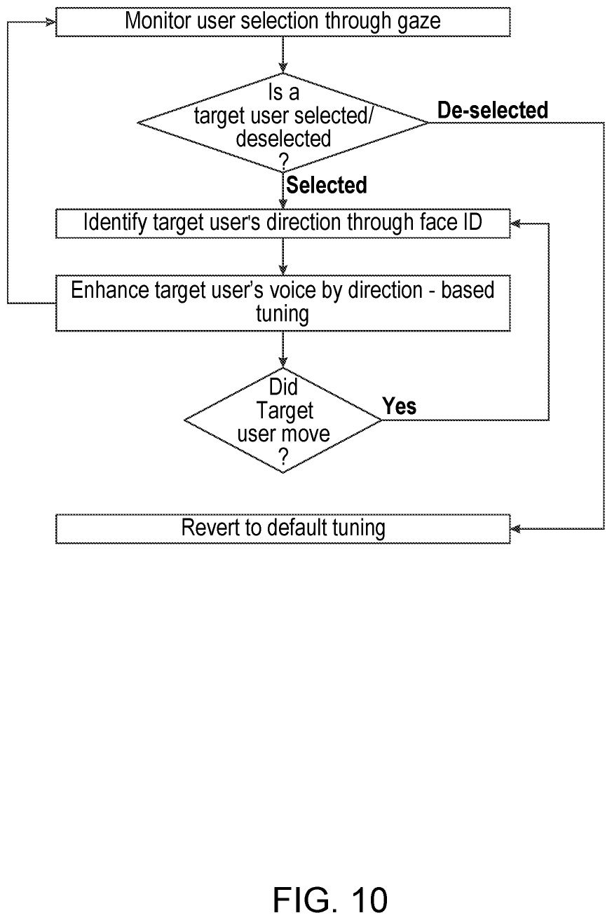

FIGS. 9 and 10 depict illustrative schematic diagrams for tracking, in accordance with one or more example embodiments of the present disclosure.

FIG. 9 shows the algorithm implementation for tracking an in-room user's voice through touch. FIG. 10 shows the algorithm implementation for enhancing an in-room user's voice through eye gaze.

Referring to FIG. 9, a remote user at the remote side may monitor an in-room user at the in-room side and may select the in-room user by touching a screen on the remote side. The metadata information that was passed on from the in-room side to the remote side may be used to identify the selected in-room user through its face ID. Based on that, on the remote side, the device may steer a beam former in the direction of the selected in-room user. It is understood that the above descriptions are for purposes of illustration and are not meant to be limiting.

Referring to FIG. 10, a remote device may perform smart framing of an in-room user's voice through gaze. For example, the remote user may monitor an in-room user at the in-room side through gaze and select that user. Based on that, on the remote side, the device may identify the selected in-room user through face ID and enhance the voice of the in-room user by direction-based tuning. It is understood that the above descriptions are for purposes of illustration and are not meant to be limiting.

In one or more embodiments, the far end (remote) processing is not controlled by the near-end (in-room) device. The processing happens within the near-end device where the experience is felt. The processing in the near-end device involves: 1) analyzing video stream coming from the in-room device, 2) detecting in-room users through face ID, 3) computing in-room users' physical locations through pixel count, and/or 4) combining the locations with Spatialization IP for smart framing, speaker tracking, and equalization.

In one or more embodiments, a tracking system may use touch/eye gaze on the near-end device to select a particular in-room user in the far-end. The tracking system may compute in-room user physical locations on the near-end device. The tracking system may apply smart framing on spatialization.

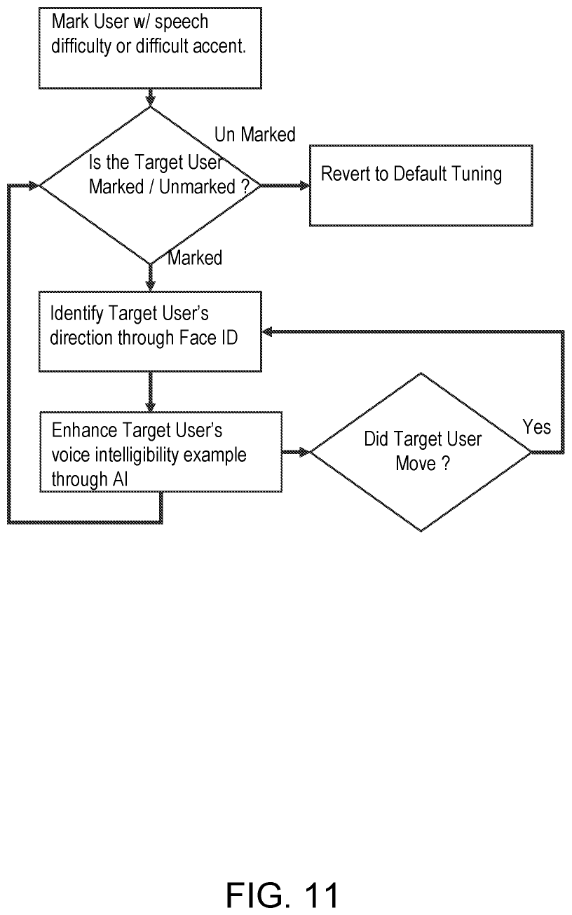

FIG. 11 depicts an illustrative schematic diagram for tracking, in accordance with one or more example embodiments of the present disclosure.

Referring to FIG. 11, there is shown a flow chart for targeting a specific user.

In scenarios, where the speech of one or more users is not very easy to understand either because of difficult accent or speech difficulty, the tracking system may target those users for improving their speech intelligibility. For example, if a far end user finding User B difficult to be understood, he/she will mark User B. Once marked, whenever User B speaks, his/her speech will be processed separately to improve speech intelligibility. When the user B is marked, the tracking system may identify the user B's direction using the face ID and then enhance the user B's voice.

It is understood that the above descriptions are for purposes of illustration and are not meant to be limiting.

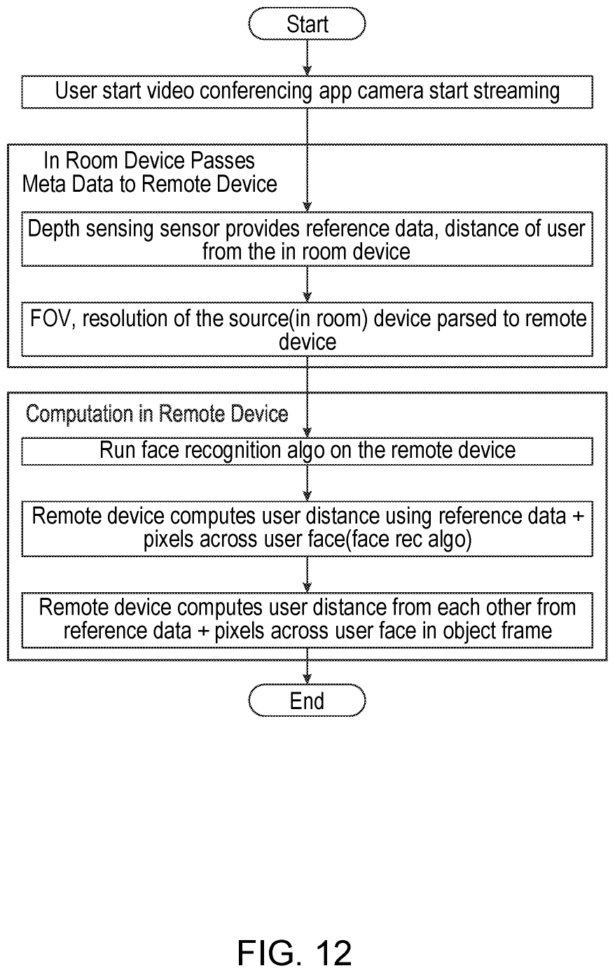

FIG. 12 depicts an illustrative schematic diagram for tracking, in accordance with one or more example embodiments of the present disclosure.

Referring to FIG. 12, there is shown a flow chart for computing in-room users' physical locations.

An in-room user may start the videoconferencing application such that the in-room camera starts streaming.

On the in-room device side, the in-room device may utilize a depth sensor in order to provide reference data, distance of a particular in-room user, field of view of the in-room camera, and/or resolution of the in-room camera, which is then parsed to the remote device.

On the remote device compute station is performed in order to compute the in-room users' physical locations. For example, the remote device may run a face recognition algorithm and compute user distance using data received from the in-room device. For example, reference data and pixels across a user's face. The remote device may then compute users' distances from each other using the reference data and pixels across users' faces in object frames.

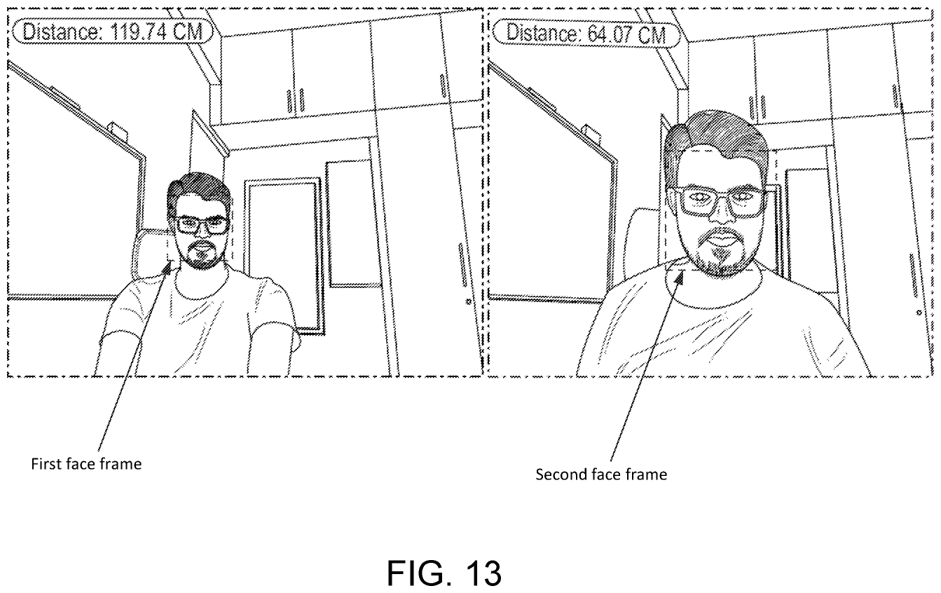

FIG. 13 depicts an illustrative schematic diagram for tracking, in accordance with one or more example embodiments of the present disclosure.

Referring to FIG. 13, there is shown depth capture results for two distances using the pixel count algorithm. On the remote device, a face recognition algorithm may run and detect a face of a user. The pixel data received from the in-room device may be used to compute the distances of the user. The distances may be depth information and relative distance between users. The pixel count may be determined by running a pixel count algorithm that provides distances. For example, determining the number of pixels in a reference frame, which is received from the in-room device, may result in determining a distance of an in-room user from the in-room camera. The remote device continues to calculate the pixel count within the reference frame as the user moves around. When the number of pixels is higher than the number of pixels of the reference frame, this indicates that the in-room user is closer to the in-room camera. When the number of pixels is lower than the number of pixels of the reference frame, this indicates that the in-room user is farther from the in-room camera. As seen in FIG. 12, two face frames (first face frame and second face frame) are captured based on a user changing his distance from the in-room camera. The first face frame pixel count determines that the user is at approximately 119 cm from the in-room camera while the second face frame pixel count determines that the user is at approximately 64 cm from the in-room camera.

It is understood that the above descriptions are for purposes of illustration and are not meant to be limiting.

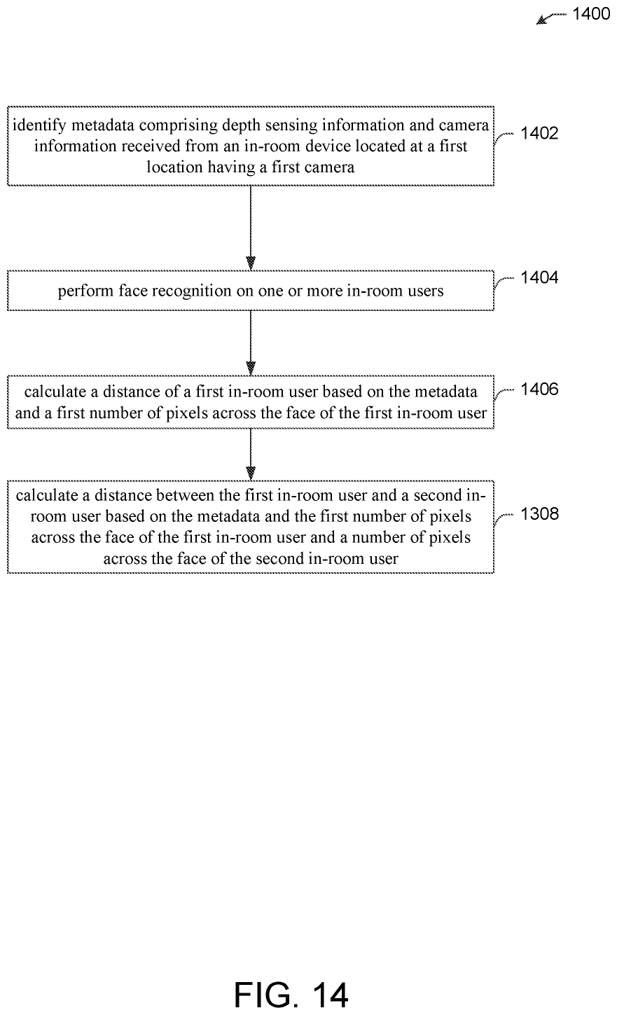

FIG. 14 illustrates a flow diagram of a process 1400 for a tracking system, in accordance with one or more example embodiments of the present disclosure.

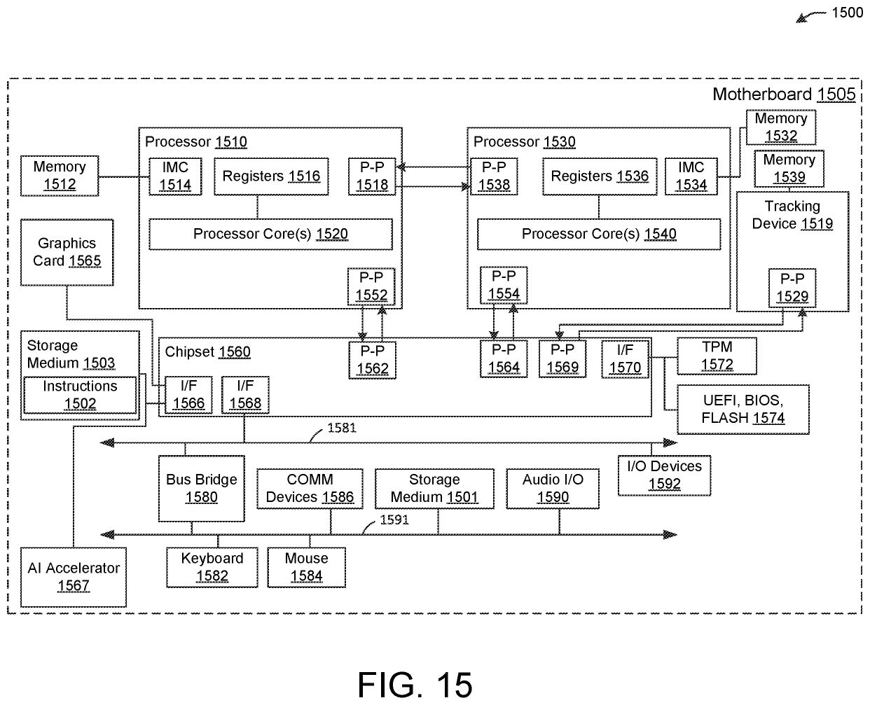

At block 1402, a device (e.g., the tracking device 1519 of FIG. 15) may identify metadata comprising depth sensing information and camera information received from an in-room device located at a first location having a first camera.

At block 1404, the device may perform face recognition on one or more in-room users.

At block 1406, the device may calculate a distance of a first in-room user based on the metadata and a first number of pixels across the face of the first in-room user.

At block 1406, the device may calculate a distance between the first in-room user and a second in-room user based on the metadata and the first number of pixels across the face of the first in-room user and the number of pixels across the face of the second in-room user.

It is understood that the above descriptions are for purposes of illustration and are not meant to be limiting.

FIG. 15 illustrates an embodiment of an exemplary system 1500, in accordance with one or more example embodiments of the present disclosure.

In various embodiments, the computing system 1500 may comprise or be implemented as part of an electronic device.

In some embodiments, the computing system 1500 may be representative, for example, of a computer system that implements one or more components of FIG. 1.

The embodiments are not limited in this context. More generally, the computing system 1500 is configured to implement all logic, systems, processes, logic flows, methods, equations, apparatuses, and functionality described herein.

The system 1500 may be a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, a handheld device such as a personal digital assistant (PDA), or other devices for processing, displaying, or transmitting information. Similar embodiments may comprise, e.g., entertainment devices such as a portable music player or a portable video player, a smart phone or other cellular phones, a telephone, a digital video camera, a digital still camera, an external storage device, or the like. Further embodiments implement larger scale server configurations. In other embodiments, the system 1500 may have a single processor with one core or more than one processor. Note that the term “processor” refers to a processor with a single core or a processor package with multiple processor cores.

The computing system 1500 is configured to implement all logic, systems, processes, logic flows, methods, apparatuses, and functionality described herein with reference to the above Figures.

As used in this application, the terms “system” and “component” and “module” are intended to refer to a computer-related entity, either hardware, a combination of hardware and software, software, or software in execution, examples of which are provided by the exemplary system 1500. For example, a component can be, but is not limited to being, a process running on a processor, a processor, a hard disk drive, multiple storage drives (of optical and/or magnetic storage medium), an object, an executable, a thread of execution, a program, and/or a computer.

By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

As shown in this figure, system 1500 comprises a motherboard 1505 for mounting platform components. The motherboard 1505 is a point-to-point interconnect platform that includes a processor 1510, a processor 1530 coupled via a point-to-point interconnects as an Ultra Path Interconnect (UPI), and a tracking device 1519. In other embodiments, the system 1500 may be of another bus architecture, such as a multi-drop bus. Furthermore, each of processors 1510 and 1530 may be processor packages with multiple processor cores. As an example, processors 1510 and 1530 are shown to include processor core(s) 1520 and 1540, respectively. While the system 1500 is an example of a two-socket (2S) platform, other embodiments may include more than two sockets or one socket. For example, some embodiments may include a four-socket (4S) platform or an eight-socket (8S) platform. Each socket is a mount for a processor and may have a socket identifier. Note that the term platform refers to the motherboard with certain components mounted such as the processors 1510 and the chipset 1560. Some platforms may include additional components and some platforms may only include sockets to mount the processors and/or the chipset.

The processors 1510 and 1530 can be any of various commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures may also be employed as the processors 1510, and 1530.

The processor 1510 includes an integrated memory controller (IMC) 1514, registers 1516, and point-to-point (P-P) interfaces 1518 and 1552. Similarly, the processor 1530 includes an IMC 1534, registers 1536, and P-P interfaces 1538 and 1554. The IMC's 1514 and 1534 couple the processors 1510 and 1530, respectively, to respective memories, a memory 1512 and a memory 1532. The memories 1512 and 1532 may be portions of the main memory (e.g., a dynamic random-access memory (DRAM)) for the platform such as double data rate type 3 (DDR3) or type 4 (DDR4) synchronous DRAM (SDRAM). In the present embodiment, the memories 1512 and 1532 locally attach to the respective processors 1510 and 1530.

In addition to the processors 1510 and 1530, the system 1500 may include a tracking device 1519. The tracking device 1519 may be connected to chipset 1560 by means of P-P interfaces 1529 and 1569. The tracking device 1519 may also be connected to a memory 1539. In some embodiments, the tracking device 1519 may be connected to at least one of the processors 1510 and 1530. In other embodiments, the memories 1512, 1532, and 1539 may couple with the processor 1510 and 1530, and the tracking device 1519 via a bus and shared memory hub.

System 1500 includes chipset 1560 coupled to processors 1510 and 1530. Furthermore, chipset 1560 can be coupled to storage medium 1503, for example, via an interface (I/F) 1566. The I/F 1566 may be, for example, a Peripheral Component Interconnect-enhanced (PCI-e). The processors 1510, 1530, and the tracking device 1519 may access the storage medium 1503 through chipset 1560.

Storage medium 1503 may comprise any non-transitory computer-readable storage medium or machine-readable storage medium, such as an optical, magnetic or semiconductor storage medium. In various embodiments, storage medium 1503 may comprise an article of manufacture. In some embodiments, storage medium 1503 may store computer-executable instructions, such as computer-executable instructions 1502 to implement one or more of processes or operations described herein, (e.g., process 1400 of FIG. 14). The storage medium 1503 may store computer-executable instructions for any equations depicted above. The storage medium 1503 may further store computer-executable instructions for models and/or networks described herein, such as a neural network or the like. Examples of a computer-readable storage medium or machine-readable storage medium may include any tangible media capable of storing electronic data, including volatile memory or non-volatile memory, removable or non-removable memory, erasable or non-erasable memory, writeable or re-writeable memory, and so forth. Examples of computer-executable instructions may include any suitable types of code, such as source code, compiled code, interpreted code, executable code, static code, dynamic code, object-oriented code, visual code, and the like. It should be understood that the embodiments are not limited in this context.

The processor 1510 couples to a chipset 1560 via P-P interfaces 1552 and 1562 and the processor 1530 couples to a chipset 1560 via P-P interfaces 1554 and 1564. Direct Media Interfaces (DMIs) may couple the P-P interfaces 1552 and 1562 and the P-P interfaces 1554 and 1564, respectively. The DMI may be a high-speed interconnect that facilitates, e.g., eight Giga Transfers per second (GT/s) such as DMI 3.0. In other embodiments, the processors 1510 and 1530 may interconnect via a bus.

The chipset 1560 may comprise a controller hub such as a platform controller hub (PCH). The chipset 1560 may include a system clock to perform clocking functions and include interfaces for an I/O bus such as a universal serial bus (USB), peripheral component interconnects (PCIs), serial peripheral interconnects (SPIs), integrated interconnects (I2Cs), and the like, to facilitate connection of peripheral devices on the platform. In other embodiments, the chipset 1560 may comprise more than one controller hub such as a chipset with a memory controller hub, a graphics controller hub, and an input/output (I/O) controller hub.

In the present embodiment, the chipset 1560 couples with a trusted platform module (TPM) 1572 and the UEFI, BIOS, Flash component 1574 via an interface (I/F) 1570. The TPM 1572 is a dedicated microcontroller designed to secure hardware by integrating cryptographic keys into devices. The UEFI, BIOS, Flash component 1574 may provide pre-boot code.

Furthermore, chipset 1560 includes the I/F 1566 to couple chipset 1560 with a high-performance graphics engine, graphics card 1565. In other embodiments, the system 1500 may include a flexible display interface (FDI) between the processors 1510 and 1530 and the chipset 1560. The FDI interconnects a graphics processor core in a processor with the chipset 1560.

Various I/O devices 1592 couple to the bus 1581, along with a bus bridge 1580 which couples the bus 1581 to a second bus 1591 and an I/F 1568 that connects the bus 1581 with the chipset 1560. In one embodiment, the second bus 1591 may be a low pin count (LPC) bus. Various devices may couple to the second bus 1591 including, for example, a keyboard 1582, a mouse 1584, communication devices 1586, a storage medium 1501, and an audio I/O 1590.

The artificial intelligence (AI) accelerator 1567 may be circuitry arranged to perform computations related to AI. The AI accelerator 1567 may be connected to storage medium 1503 and chipset 1560. The AI accelerator 1567 may deliver the processing power and energy efficiency needed to enable abundant-data computing. The AI accelerator 1567 is a class of specialized hardware accelerators or computer systems designed to accelerate artificial intelligence and machine learning applications, including artificial neural networks and machine vision. The AI accelerator 1567 may be applicable to algorithms for robotics, internet of things, other data-intensive and/or sensor-driven tasks.

Many of the I/O devices 1592, communication devices 1586, and the storage medium 1501 may reside on the motherboard 1505 while the keyboard 1582 and the mouse 1584 may be add-on peripherals. In other embodiments, some or all the I/O devices 1592, communication devices 1586, and the storage medium 1501 are add-on peripherals and do not reside on the motherboard 1505.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, yet still co-operate or interact with each other.

In addition, in the foregoing Detailed Description, various features are grouped together in a single example to streamline the disclosure. This method of disclosure is not to be interpreted as reflecting an intention that the claimed examples require more features than are expressly recited in each claim. Rather, as the following claims reflect, the inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code to reduce the number of times code must be retrieved from bulk storage during execution. The term “code” covers abroad range of software components and constructs, including applications, drivers, processes, routines, methods, modules, firmware, microcode, and subprograms. Thus, the term “code” may be used to refer to any collection of instructions which, when executed by a processing system, perform a desired operation or operations.

Logic circuitry, devices, and interfaces herein described may perform functions implemented in hardware and implemented with code executed on one or more processors. Logic circuitry refers to the hardware or the hardware and code that implements one or more logical functions. Circuitry is hardware and may refer to one or more circuits. Each circuit may perform a particular function. A circuit of the circuitry may comprise discrete electrical components interconnected with one or more conductors, an integrated circuit, a chip package, a chipset, memory, or the like. Integrated circuits include circuits created on a substrate such as a silicon wafer and may comprise components. And integrated circuits, processor packages, chip packages, and chipsets may comprise one or more processors.

Processors may receive signals such as instructions and/or data at the input(s) and process the signals to generate the at least one output. While executing code, the code changes the physical states and characteristics of transistors that make up a processor pipeline. The physical states of the transistors translate into logical bits of ones and zeros stored in registers within the processor. The processor can transfer the physical states of the transistors into registers and transfer the physical states of the transistors to another storage medium.

A processor may comprise circuits to perform one or more sub-functions implemented to perform the overall function of the processor. One example of a processor is a state machine or an application-specific integrated circuit (ASIC) that includes at least one input and at least one output. A state machine may manipulate the at least one input to generate the at least one output by performing a predetermined series of serial and/or parallel manipulations or transformations on the at least one input.

The logic as described above may be part of the design for an integrated circuit chip. The chip design is created in a graphical computer programming language, and stored in a computer storage medium or data storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication.

The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher-level carrier) or in a multichip package (such as a ceramic carrier that has either or both surface interconnections or buried interconnections). In any case, the chip is then integrated with other chips, discrete circuit elements, and/or other signal processing devices as part of either (a) an intermediate product, such as a processor board, a server platform, or a motherboard, or (b) an end product.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device, the device comprising processing circuitry coupled to storage, the processing circuitry configured to:
identify metadata comprising depth sensing information and camera information received from an in-room device located at a first location having a first camera;
perform face recognition on one or more in-room users;
calculate a distance of a first in-room user based on the metadata and a first number of pixels across the face of the first in-room user;
calculate a distance between the first in-room user and a second in-room user based on the metadata and the first number of pixels across the face of the first in-room user and a number of pixels across the face of the second in-room user.

2. The device of claim 1, wherein the depth sensing information is associated with the one or more in-room users located in a field of view of the first camera.

3. The device of claim 1, wherein the depth sensing information provides distances of the one or more in-room users.

4. The device of claim 1, wherein the metadata information comprises reference frame information associated with each of the one or more in-room users captured at one or more time intervals.

5. The device of claim 4, wherein the one or more time intervals comprises a start of a conferencing session.

6. The device of claim 1, wherein the metadata information comprises a field of view (FOV) of the first camera and a resolution of the first camera.

7. The device of claim 1, wherein the processing circuitry is further configured to analyze a video stream coming from the in-room device.

8. The device of claim 1, wherein the processing circuitry is further configured to:
select the first in-room user of the second in-room user by utilizing touch; and
Steer a beamformer in a direction of the first in-room user or the second in-room user.

9. The device of claim 1, wherein the processing circuitry is further configured to:
monitor at least one of the one or more in-room users using gaze; and
enhance voice data of the at least one of the one or more in-room users by direction-based tuning.

10. A non-transitory computer-readable medium storing computer-executable instructions which when executed by one or more processors result in performing operations comprising:
identifying metadata comprising depth sensing information and camera information received from an in-room device located at a first location having a first camera;
performing face recognition on one or more in-room users;
calculating a distance of a first in-room user based on the metadata and a first number of pixels across the face of the first in-room user;
calculating a distance between the first in-room user and a second in-room user based on the metadata and the first number of pixels across the face of the first in-room user and a number of pixels across the face of the second in-room user.

11. The non-transitory computer-readable medium of claim 10, wherein the depth sensing information is associated with the one or more in-room users located in a field of view of the first camera.

12. The non-transitory computer-readable medium of claim 10, wherein the depth sensing information provides distances of the one or more in-room users.

13. The non-transitory computer-readable medium of claim 10, wherein the metadata information comprises reference frame information associated with each of the one or more in-room users captured at one or more time intervals.

14. The non-transitory computer-readable medium of claim 13, wherein the one or more time intervals comprises a start of a conferencing session.

15. The non-transitory computer-readable medium of claim 10, wherein the metadata information comprises a field of view (FOV) of the first camera and a resolution of the first camera.

16. The non-transitory computer-readable medium of claim 10, wherein the operations further comprise analyze a video stream coming from the in-room device.

17. The non-transitory computer-readable medium of claim 10, wherein the operations further comprise:
selecting the first in-room user of the second in-room user by utilizing touch; and
Steer a beamformer in a direction of the first in-room user or the second in-room user.

18. The non-transitory computer-readable medium of claim 10, wherein the operations further comprise:
monitor at least one of the one or more in-room users using gaze; and
enhance voice data of the at least one of the one or more in-room users by direction-based tuning.

19. A method comprising:
identifying metadata comprising depth sensing information and camera information received from an in-room device located at a first location having a first camera;
performing face recognition on one or more in-room users;
calculating a distance of a first in-room user based on the metadata and a first number of pixels across the face of the first in-room user;
calculating a distance between the first in-room user and a second in-room user based on the metadata and the first number of pixels across the face of the first in-room user and a number of pixels across the face of the second in-room user.

20. The method of claim 19, wherein the depth sensing information is associated with the one or more in-room users located in a field of view of the first camera.
